(19) United States
(12) Patent Application Publication
(10) Pub. No.: US 2023/0061547 A1
(43) Pub. Date: Mar. 2, 2023

(54) USING MACHINE LEARNING TO DYNAMICALLY DETERMINE SHIPPING INFORMATION

(71) Applicant: PROJECT44, Chicago, IL (US)

(72) Inventors: Eric Olin Russell, Skokie, IL (US); Ellen Grace Crist, Chicago, IL (US); Matthew George Dzugan, Forest Park, IL (US); Issa Issa, Chicago, IL (US); Michael Christopher Edwards, Chicago, IL (US)

(21) Appl. No.: 17/463,404

(22) Filed: Aug. 31, 2021

(51) Int. Cl. G06Q 10/08; G06Q 50/28; G06Q 10/06; G06K 9/62; G06N 20/00

(52) U.S. Cl. CPC G06Q 10/083; G06Q 50/28; G06Q 10/06315; G06K 9/6256; G06N 20/00

(57) ABSTRACT

Systems and methods for using machine learning to dynamically determine shipping information are disclosed. According to certain aspects, an electronic device may receive location data for a set of vehicles that may be associated with a shipping agreement, wherein the electronic device may input the location data and shipping agreement parameters into a machine learning model which outputs a set of likelihoods of the respective set of vehicles actually transporting products associated with the shipping agreement. The electronic device may enable a customer computing device to access this information along with any determined updates to the shipping agreement.

### FIELD

The present disclosure is directed to improvements related to dynamically determining information associated with shipping agreements. More particularly, the present disclosure is directed to platforms and technologies for using machine learning to analyze shipping data to assess which vehicles are transporting which products.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers entities having transport equipment to transport the physical items). There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

Currently, when a shipping agreement is brokered or reached between a shipper and a carrier, the shipper knows that the carrier is going to complete the shipping agreement but has minimal details on the status of the shipment. For example, the shipper does not know which vehicle which truck, train, etc.) of the shipper is actually transporting the items, and therefore does not have an accurate assessment of where the shipment is, when it is scheduled to be delivered, or whether it was actually delivered. Instead, the shipping agreement is typically started and completed, and at some point after that the shipper is notified of the completed shipping agreement.

Accordingly, there is an opportunity for platforms and technologies to leverage data sources to effectively and accurately determine which vehicle is transporting a shipment, and accordingly update a status for a shipping agreement.

### SUMMARY

In an embodiment, a computer-implemented method of using machine learning for transportation assignment is provided. The method may include: training, by a computer processor, a machine learning model using a training dataset comprising (i) a training set of origin locations, (ii) a training set of destination locations, and (iii) a training set of location data; storing the machine learning model in a memory; accessing, by the computer processor, input data comprising (i) order information indicating a origin location and a destination location for an order for a set of products, and (ii) a set of location data associated with a carrier entity and identifying a set of locations respectively associated with a set of vehicles associated with the carrier entity; analyzing, by the computer processor using the machine learning model, the input data; and based on the analyzing, outputting, by the machine learning model, an identification of a vehicle of the set of vehicles that is most likely to be transporting the set of products.

In another embodiment, a system for using machine learning for transportation assignment is provided. The system may include: a memory storing a set of computer-readable instructions and data associated with a machine learning model; and a processor interfaced with the memory, and configured to execute the set of computer-readable instructions to cause the processor to: train the machine learning model using a training dataset comprising (i) a training set of origin locations, (ii) a training set of destination locations, and (iii) a training set of location data, access input data comprising (i) order information indicating a origin location and a destination location for an order for a set of products, and (ii) a set of location data associated with a carrier entity and identifying a set of locations respectively associated with a set of vehicles associated with the carrier entity, analyze, using the machine learning model, the input data, and based on the analyzing, output, by the machine learning model, an identification of a vehicle of the set of vehicles that is most likely to be transporting the set of products.

Further, in an embodiment, a non-transitory computer-readable storage medium configured to store instructions executable by a computer processor is provided. The instructions may include: instructions for training a machine learning model using a training dataset comprising (i) a training set of origin locations, (ii) a training set of destination locations, and (iii) a training set of location data; instructions for storing the machine learning model in a memory; instructions for accessing input data comprising (i) order information indicating a origin location and a destination location for an order for a set of products, and (ii) a set of location data associated with a carrier entity and identifying a set of locations respectively associated with a set of vehicles associated with the carrier entity; instructions for analyzing, using the machine learning model, the input data; and instructions for, based on the analyzing, outputting, by the machine learning model, an identification of a vehicle of the set of vehicles that is most likely to be transporting the set of products.

Additionally, in an embodiment, a computer-implemented method of assessing transportation of products is provided. The method may include: accessing, by a processor, shipment information indicating a destination location for a shipment for a set of products to be transported by a set of vehicles associated with a carrier entity; receiving, by the processor from a computing device via a network connection, a set of locations generated by a set of electronic logging devices respectively associated with the set of vehicles associated with the carrier entity; analyzing, by the computer processor, the shipment information and the set of locations; and based on the analyzing, determining an identification of a vehicle of the set of vehicles that is most likely to be transporting the set of products.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 depicts an exemplary deep learning artificial neural network (DNN) that may be employed by the systems and methods, in accordance with some embodiments.

FIG. 3 depicts an example signal diagram associated with using machine learning for transportation assignment, in accordance with some embodiments.

FIG. 4 depicts an example dashboard interface for a shipper entity, in accordance with some embodiments.

FIG. 5 illustrates an example flow diagram of using machine learning for transportation assignment, in accordance with some embodiments.

### DETAILED DESCRIPTION

The present embodiments may relate to, inter alia, analyzing tracking information associated with a shipping agreement or job using a machine learning model to determine a vehicle that is most likely to be transporting physical items associated with the shipping agreement, and updating a status for the shipping agreement for access by a customer (e.g., a shipper entity). According to certain aspects, systems and methods may initially train the machine learning model using a set of training data, and store the machine learning model in memory for subsequent use.

Subsequent to a shipping agreement or agreement being reached between a shipper and a carrier, the systems and methods may interface with a set of data sources and receive order or tracking information that indicates locations of vehicles operated by the carrier. The systems and methods may input the received information into the machine learning model, which may output a set of likelihoods or probabilities that a respective set of vehicles are actually transporting items/products associated with the shipping agreement. The systems and methods may update a status associated with the shipping agreement, and may enable a customer (e.g., the shipper) to access a dashboard or other interface that informs of the status of and other information associated with the shipping agreement. According to certain embodiments, the systems and methods may perform the analyses without use of a machine learning model.

The systems and methods therefore offer numerous benefits. In particular, the systems and methods use machine learning or artificial intelligence techniques to effectively and accurately determine which vehicles or assets are actually transporting physical goods or items associated with a shipping agreement. Thus, the systems and methods are able to accurately determine status updates for shipping agreements, including locations, estimated delivery times, and/or other information. Additionally, customers benefit from being able to access updated information associated with shipping agreements, such as to streamline supply chain gaps and provide accurate updates to their customers, among other benefits. It should be appreciated that additional benefits are envisioned.

The systems and methods discussed herein address a business challenge, namely a business challenge related to improving how shipper entities track their shipments across one or more carrier entities. In conventional platforms, shipper entities have access to which carrier entities are completing which shipping agreements, but do not necessarily know the locations of the vehicles that are transporting the products associated with the shipping agreements. In contrast, the systems and methods are able to ingest or access data from multiple data sources and analyze that data to assess the locations and statuses of shipments, thus enabling the shipping entities to review the information and more effectively and efficiently manage operations.

Therefore, the systems and methods do not merely recite the performance of some business practice known from the pre-Internet world (tracking a shipment) along with the requirement to perform it on the Internet. Instead, the systems and methods incorporate computer networks that enable communications among shipper entities, carrier entities, and data sources such as electronic logging devices, among other entities and components. Thus, the systems and methods are necessarily rooted in computer technology in order to overcome a problem specifically arising in logistics technologies.

According to implementations, the systems and methods may support a dynamic, real-time or near-real-time collection, analysis, and communication of any data that may be associated with shipping conditions. In particular, the systems and methods may dynamically and automatically access or retrieve data indicative of operational conditions such as vehicle locations, analyze the data, and determine shipping conditions and updates. In these ways, the systems and methods discussed herein address technical challenges, namely establishing dynamic data collection, analysis, and communication across dedicated computer systems, including different systems for different carrier entities and shipper entities.

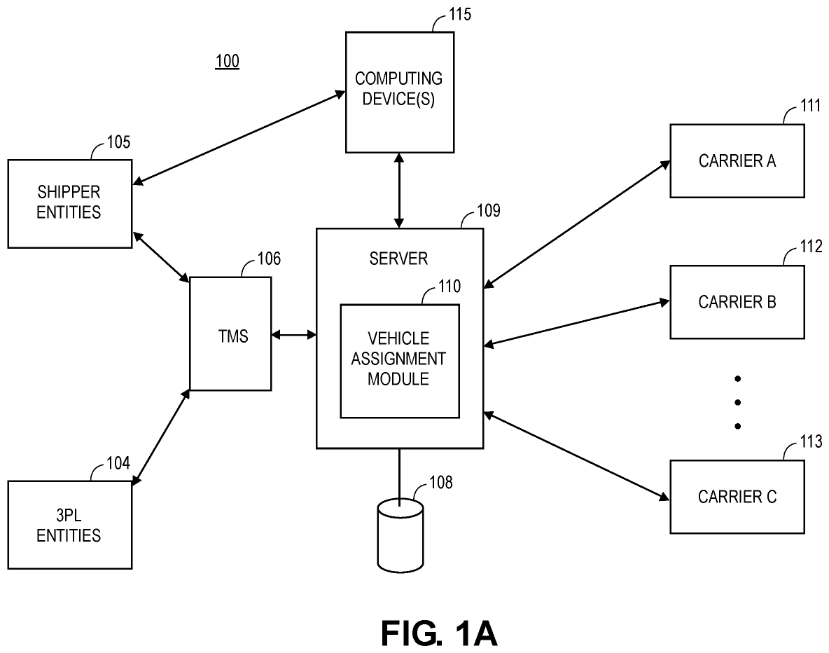

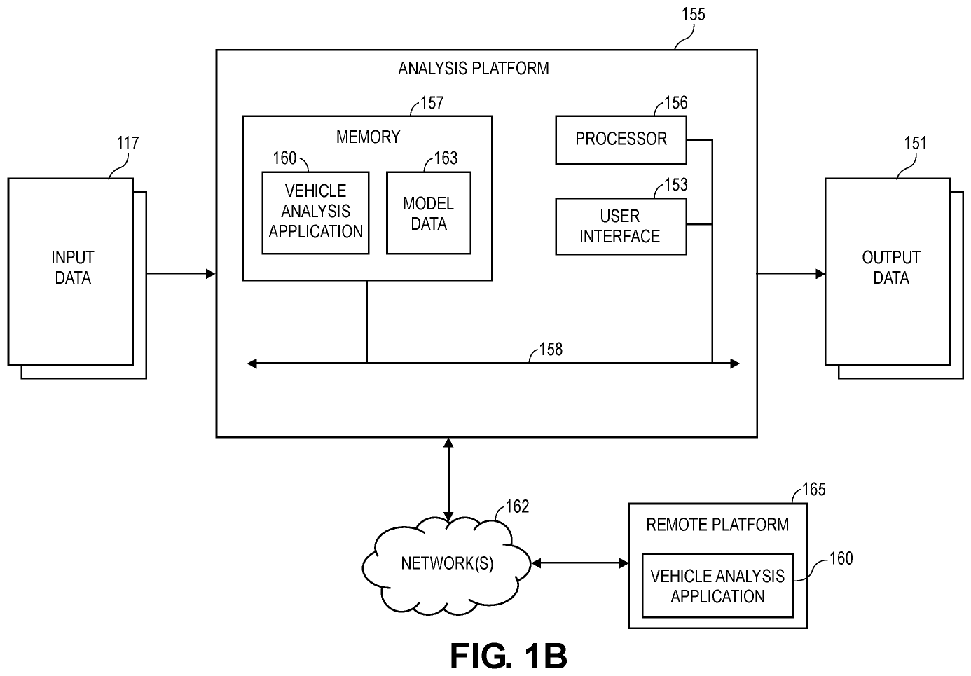

FIG. 1 illustrates an overview of a system 100 of components configured to facilitate the systems and methods. It should be appreciated that the system 100 is merely exemplary and that alternative or additional components are envisioned.

As illustrated in FIG. 1, the system 100 includes a set of shipper entities 105 and a set of 3PL entities 104. Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. It should be appreciated that various amounts of the shipper entities 105 are envisioned.

Each of the 3PL entities 104 may be a third-party provider that the set of shipper entities 105 may use to outsource certain elements associated with handling and managing the transportation of the physical goods. In some embodiments, one or more of the shipper entities 105 may include one or more of the 3PL entities 104 (or vice-versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities 104 may be a single service or may be a system-wide bundle of services capable of managing various aspects of a supply chain (e.g., transportation of physical goods). It should be appreciated that various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to embodiments, the transportation of goods may be accomplished via marine or water (i.e., using boats or ships), air (i.e., using aircraft), rail (i.e., using trains), or road (i.e., using trucks, cars, or other land-based vehicles). The term “vehicle,” as used herein, may refer to any vessel or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to embodiments, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to embodiments, the TMS 106 may support specific and particular communication capabilities with the other entities of the system 100. In particular, the TMS 106 may support communication with the other entities via different components and protocols.

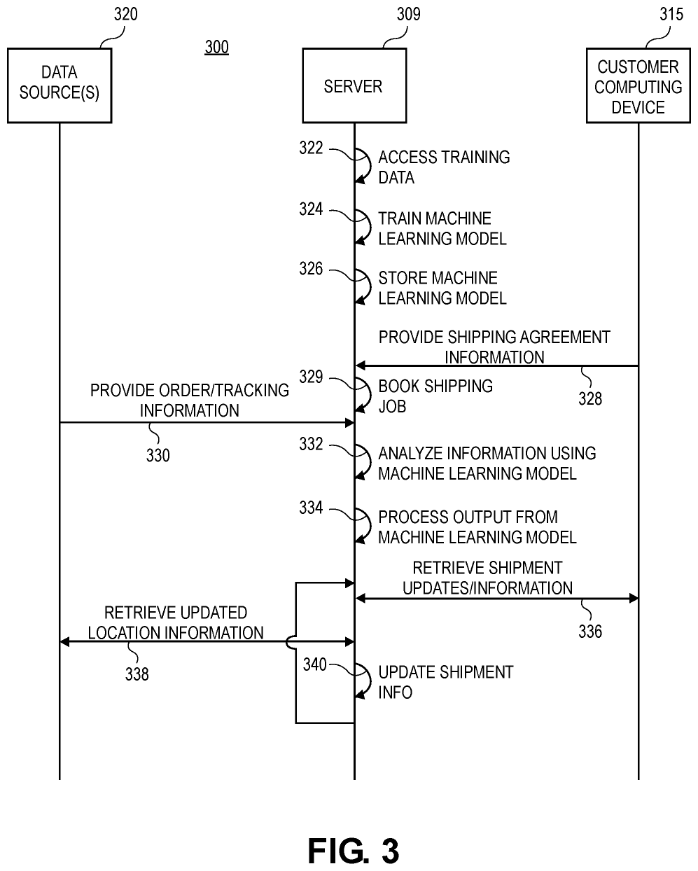

As illustrated in FIG. 1, the system 100 may include a server 109 that may interface and communicate with at least the TMS 106, the set of carrier entities 111, 112, 113, and a set of computing devices 115. The server 109 may include any combination or hardware and software components, and may be associated with any type of entity or individual. The server 109 may support execution of a vehicle assignment module 110. According to embodiments, the vehicle assignment module 110 may receive tracking data associated with a shipping agreement and determine, by inputting at least the tracking data into a machine learning model, which vehicle of a given carrier entity is actually transporting the items associated with the shipping agreement, as discussed herein with respect to FIGS. 1B and 3. The vehicle assignment module 110 may interface with a database 108 or other type of memory configured to store data accessible by the vehicle assignment module 110.

The set of computing devices 115 may enable users access to a dashboard, interface, or the like that may include updates to shipping agreements, as determined by the vehicle assignment module 110. In embodiments, the set of computing devices 115 may be associated with one or more of the shipper entities 105. Accordingly, the set of computing devices 115 may interface with the server 109 and/or the shipper entities 105.

Although FIG. 1 depicts the server 109 in communication with the TMS 106 and the set of carrier entities 111, 1112, 113, it should be appreciated that alternative configurations are envisioned. In one particular implementation, the TMS 106, the 3PL entity 104, and the server 109 may be combined as a single entity (i.e., the server 109 may communicate directly with the shipper entities 105 and the set of carrier entities 111, 112, 113). In another implementation, either the TMS 106 or the 3PL entity 104 may be combined with the server 109 as a single entity capable of performing the respective functionalities.

Although not depicted in FIG. 1, the system 100 may support one or more computer networks that may enable communication between and among the entities and components of the system 100. In embodiments, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 and the computing device(s) 115 may communicate with the TMS 106 (and/or with the vehicle assignment module 110) via an Internet connection.

Generally, carrier entities provide base pricing rates to shipper entities and to 3PL entities, where the 3PL entities typically mark up or increase the base pricing rates and sell to shipper entities at the increase amount. Conventionally, a carrier entity charges a price (“Price #1” and referred to herein as “base pricing rate”) that the carrier entity receives from a shipper or 3PL entity to transport freight, and incurs a cost (“Cost #1”) to transport the freight. Similarly, a 3PL entity pays a cost (“Cost #2”, which is the same as Price #1 or the base pricing rate) to a carrier entity to have freight transported, and charges a price (“Price #2”) to a shipper entity to have the freight transported. Further, a shipper entity pays a cost (“Cost #3”, which may be same as Price #1 (i.e., the base pricing rate) or Price #2) to a carrier entity or to a 3PL entity for the freight transport.

In some situations, a carrier entity may calculate a “dynamic pricing rate” using Cost #1 and/or Price #1 (i.e., the base pricing rate) along with at least one “dynamic pricing rule” and at least one “current condition.” Effectively, the dynamic pricing rate is the base pricing rate that is adjusted (i.e., increased or decreased) based on the dynamic pricing rule and/or the current condition. Accordingly, a 3PL entity pays a cost (i.e., the dynamic pricing rate) to the carrier entity to have freight transported, and charges a price (“Price #3”) to a shipper entity to have the freight transported. Additionally, a shipper entity pays a cost (which could be either the dynamic pricing rate or Price #3) to a carrier entity or to a 3PL entity for the freight transport. Shipper entities and carrier entities may communicate and retrieve price and cost information via respective sets of APIs, or using other connections or protocols. Generally, a shipping agreement is reached between a shipper entity and a carrier entity (and in some cases, a 3PL entity), where the carrier entity transports a set of products associated with the shipper entity, for agreed-upon costs/prices.

It should be appreciated that the components and entities of the system 100 may include and support various combinations of hardware and software components capable of facilitating various of the functionalities of the systems and methods. For example, the components and entities of the system 100 may generally support one or more computer processors, communication modules (e.g., transceivers), memories, and/or other components.

FIG. 1B an example environment 150 in which input data 117 is processed into output data 151 via an analysis platform 155, according to embodiments. The analysis platform 155 may be implemented on any computing device or combination of computing devices, including the server 109 as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The analysis platform 155 may further include a user interface 153 configured to present content (e.g., input data, output data, processing data, and/or other information). Additionally, a user may review results of an vehicle assignment analysis and make selections to the presented content via the user interface 153, such as to review output data presented thereon, make selections, and/or perform other interactions. The user interface 153 may be embodied as part of a touchscreen configured to sense touch interactions and gestures by the user. Although not shown, other system components communicatively coupled to the system bus 158 may include input devices such as cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a vehicle analysis application 160) data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The analysis platform 155 may operate in a networked environment and communicate with one or more remote platforms, such as a remote platform 165, via a network 162, such as a local area network (LAN), a wide area network (WAN), or other suitable network. The platform 165 may be implemented on any computing device, including any of the set of computing devices 115 as discussed with respect to FIG. 1A, and may include many or all of the elements described above with respect to the platform 155. In some embodiments, the vehicle analysis application 160 as will be further described herein may be stored and executed by the remote platform 165 instead of by or in addition to the platform 155.

Generally, each of the input data 117 and the output data 152 may be embodied as any type of electronic document, file, template, etc., that may include various graphical/visual and/or textual content, and may be stored in memory as program data in a hard disk drive, magnetic disk and/or optical disk drive in the analysis platform 155 and/or the remote platform 165. The analysis platform 155 may support one or more techniques, algorithms, or the like for analyzing the input data 117 to generate the output data 151. In particular, the vehicle analysis application 160 may analyze tracking data and other parameters associated with a shipping agreement to calculate a set of likelihoods of a respective set of vehicles physically transporting the products associated with the shipping agreement. Based on the analysis, the vehicle analysis application 160 may output data (i.e., the output data 151) that indicates that calculated set of likelihoods. Additionally, the vehicle analysis application 160 may assess or determine how the status of the shipping agreement may change based on the calculated set of likelihoods, where that information or data may also be embodied as the output data 151. The memory 157 may store the output data 151 and other data that the analysis platform 155 generates or uses in associated with the analysis of the input data 117.

According to embodiments, the vehicle analysis application 160 may employ machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the input data 117 is a training dataset, the vehicle analysis application 160 may analyze/process the input data 117 to generate a machine learning model(s) for storage as part of model data 163 that may be stored in the memory 157.

When the input data 117 comprises sensor or tracking data associated with a shipping agreement to be analyzed using the machine learning model, the vehicle analysis application 160 may analyze or process the input data 117 using the machine learning model to generate the output data 151 that may comprise various information that indicates a set of likelihoods that a respective set of vehicles is transporting products associated with the shipping agreement. In embodiments, various of the output data 151 may be added to the machine learning model stored as part of the model data 163. In analyzing or processing the input data 117, the vehicle analysis application 160 may use any of the output data 151 previously generated by the analysis platform 155.

The vehicle analysis application 160 (or another component) may cause the output data 151 (and, in some cases, the training or input data 117) to be displayed on the user interface 153 for review by the user of the analysis platform 155. Additionally, the vehicle analysis application 160 may analyze or examine the output data 151 to determine status updates to shipping agreements, which may be displayed on the user interface 153 as part of a dashboard, interface, or the like. The user may select to review and/or modify the displayed data. For instance, the user may review the output data 151 to assess shipping updates, plan additional shipping agreements, and/or facilitate other functionalities.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 156 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML, R, Stata, AI libraries). In some embodiments, the computer program product may be part of a cloud network of resources.

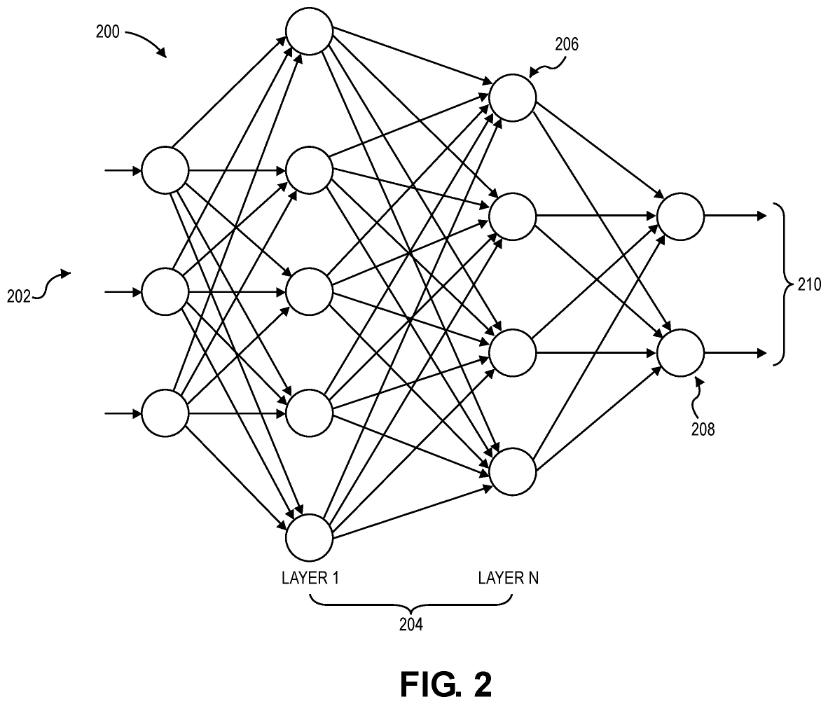

FIG. 2 depicts an exemplary deep learning artificial neural network (DNN) 200, which may be used in conjunction with the machine learning techniques as discussed herein. The DNN 200 may be trained and/or operated by the analysis platform 155 of FIG. 1B, for example. The DNN 200 may include a plurality of layers, each of which include any number of respective neurons, or nodes.

The DNN 200 may include an input layer 202, one or more hidden layers 204, and an output layer 208. Each of the layers in the DNN may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of DNNs are possible.

The input layer 302 may correspond to a large number of input parameters (e.g., one million inputs), in some embodiments, and may be analyzed serially or in parallel. Further, various neurons and/or neuron connections within the DNN may be initialized with any number of weights and/or other training parameters. Each of the neurons in the hidden layers 204 may analyze one or more of the input parameters from the input layer 202, and/or one or more outputs from a previous one or more of the hidden layers 204, to generate a decision 210 or other output. The output layer 208 may generate the decision 210 or more outputs, each indicating a prediction or an expected value. The number of input neurons may be stored as a predetermined value, and used to initialize a network for training.

In some embodiments and/or scenarios, the output layer 208 may include only a single output 210. For example, a neuron may correspond to one of the neurons in a hidden layer 206. Each of the inputs to the neuron may be weighted according to a set of weights W1 through Wi, determined during the training process (for example, if the neural network is a recurrent neural network) and then applied to a node that performs an operation a. The operation a may include computing a sum, a difference, a multiple, or a different operation. In some embodiments weights are not determined for some inputs. In some embodiments, neurons of weight below a threshold value may be discarded/ignored. The sum of the weighted inputs, r1, may be input to a function which may represent any suitable functional operation on r1. The output of the function may be provided to a number of neurons of a previous/subsequent layer or as an output 210 of the DNN. In some embodiments, the DNN may include one or more convolutional neural network (CNN) layers.

FIG. 3 depicts a signal diagram 300 with various functionalities associated with the described embodiments. The signal diagram 300 includes the following components: one or more data sources 320, a server 309, and a customer computing device 315. According to embodiments, the data source(s) 320 may be associated with one or more shipping entities, one or more transportation management systems, and/or other data vendors. Further, the server 309 may be, for example, the server 109 as described with respect to FIG. 1A and may implement the asset analysis platform 155 as discussed with respect to FIG. 1B. Additionally, the customer computing device 315 may be, for example, the computing device 115 as discussed with respect to FIG. 1A and may be associated with a carrier entity. Generally, the carrier entity associated with the computing device 115 may reach a shipping agreement with a shipper entity to transport goods or products associated with an order.

Although the signal diagram 300 is described as employing artificial intelligence and machine learning to implement and facilitate various of the functionalities, it should be appreciated that the signal diagram 300 may operate without artificial intelligence or machine learning. In this regard, the signal diagram 300 may access tracking information from the data source(s) 320 and perform calculations on the tracking data to determine relevant output data.

The signal diagram 300 may start with the server 309 training a machine learning model. In particular, the server 309 may access (322) a set of training data or a training dataset. Generally, the set of training data may include information indicating order shipments and the initiation, shipment, and delivery thereof, and may be real-world data and/or simulated, labeled data. According to embodiments, the set of training data may include any combination of: origin locations, destination locations, location data, asset (i.e., vehicle) identifiers, product information including size, weight, and/or other data, route information, and/or other information. For example, a portion of the set of training data may indicate that a shipment of boxed goods was picked up by Truck A at 11:00 AM on July 27 at an origin location in Chicago, Ill. and delivered by Truck A at 10:00 PM on July 28 at a destination location in Indianapolis, Ind., where Truck A traveled at least in part on Interstates 90 and 65. In this example, the portion of the set of training data may further include timestamped location data (e.g., GPS coordinates) that indicates the location of Truck A at various times before, during, and after the delivery.

The server 309 may train (324) the machine learning model using the set of training data. It should be appreciated that the server 309 may train the machine learning model using any combination of one or more techniques, calculations, or the like. The server 309 may store (326) the machine learning model, for example in the database 108 as discussed with respect to FIG. 1A or the memory 157 as discussed with respect to FIG. 1B.

Before, during, or after the server 309 trains the machine learning model, the customer computing device 315 may provide (328) shipping agreement information to the server 309. According to embodiments, the shipping agreement information may include information associated with a shipping agreement that a shipper would like performed, where the information may identify the goods or products to be shipped (including physical dimensions and/or a weight of the goods/products), a pickup location, a destination location, a desired pickup time, a desired delivery time, pricing, and/or other information.

The server 309 may accordingly book (329) or finalize the shipping agreement according to the shipping agreement information provided in (328). In particular, the server 309 may interface with a carrier entity that accepts the shipping agreement according to the shipping agreement information, where the carrier entity may be associated with or interface with one or more of the data source(s) 320. Accordingly, after the shipping agreement is booked or finalized, a shipping agreement may be deemed to have been reached, and the selected carrier entity may carry out or fulfill the shipping agreement according to the requested parameters and for the specified price/cost. Additionally, it may not be known which vehicle associated with the carrier entity is actually going to pick up, transport, and deliver the products.

Before, during, and/or after the actual transporting of the products, the data source(s) 320 may provide (330) order/tracking information associated with the shipping agreement to the server 309. In particular, the order/tracking information may include a set of locations respectively associated with a set of vehicles associated with the carrier entity, where the set of locations may be timestamped. The set of locations may thus indicate which vehicles are located (and when the vehicles are located) at or near a pickup location or a destination location, along a route from the pickup location to the destination location, or otherwise in a different location. According to embodiments, the order/tracking information may be generated by a set of electronic logging devices respectively associated with the set of vehicles (i.e., each vehicle is equipped with an electronic logging device that may consistently and/or periodically provide updated location data). Further, the data source(s) 320 may continuously provide update order/tracking information to the server 309, such as when the data source(s) 320 receive updated location data from the electronic logging device(s).

The server 309 may analyze (332) the information provided in (328) and (330) using the machine learning model. In particular, the server 309 may input, into the machine learning model, at least a portion of the information provided in (330), which may include timestamped location data, and at least a portion of the information provided in (328), which may include a pickup location, a destination location, a desired pickup time, a desired delivery time, pricing, and/or other information. Generally, the analysis of the machine learning model may calculate or determine a probability or likelihood of each vehicle of the set of vehicles associated with the carrier entity being the vehicle that is actually transporting the products for the shipping agreement. It should be appreciated that the server 309 may perform the machine learning model analysis on a continuous basis as additional order/tracking data (e.g., updated location data) is provided.

As a result, the machine learning model may output a result of the analysis. According to embodiments, the output may identify the set of vehicles associated with the carrier entity, and, for each vehicle, may indicate a probability or likelihood that the vehicle is the vehicle that is actually transporting the products for the shipping agreement. For example, if the carrier entity has agreed to handle a shipping agreement and has three vehicles Truck A, Truck B, and Truck C, the machine learning model may calculate that Truck A has a 80% chance of being the truck that is transporting the shipping agreement, Truck B has a 15% chance of being the truck that is transporting the shipping agreement, and Truck C has a 5% chance of being the truck that is transporting the shipping agreement. It should be appreciated that the set of probabilities output by the machine learning model may (or may not) add up to 100%.

It should be appreciated that the machine learning model may account for different scenarios when performing its analysis. Continuing with the above example, if all of Truck A, Truck B, and Truck C are in a vicinity of a desired pickup location at a desired pickup time, and Truck A continues on a route to a desired destination location but Trucks B and C take a different route, then the machine learning model may determine a higher percentage for Truck A than for Trucks B and C. Alternatively, if only Truck A is at the desired destination location around the desired delivery time, then the machine learning model may determine a higher percentage for Truck A than for Trucks B and C. It should be appreciated that alternative and additional scenarios are envisioned.

The server 309 may process (338) the output from the machine learning model. According to embodiments, the server 309 may update a status of the shipping agreement based on the output, and may update an associated dashboard, account, interface, or the like. For example, if the output indicates that Truck A is the most likely vehicle that is transporting the products associated with the shipping agreement, then the server 309 may update a status for the shipping agreement to identify Truck A, indicate the location of Truck A, and update a delivery estimate for the products (e.g., based on the location and movement of Truck A).

The customer computing device 315 may retrieve (336), from the server 309, shipment updates and information associated with the shipping agreement. In embodiments, the customer computing device 315 may access an associated dashboard, account, interface, or the like, that may indicate any update(s) to the status of the shipping agreement. According to embodiments, the associated dashboard, account, interface, or the like may indicate the statuses of any other shipping agreements of the customer.

According to embodiments, the server 309 may retrieve (338), from the data source(s) 320, updated location information for the vehicle that is determined to be the most likely vehicle transporting the products. The server 309 may then update (340) the information associated with the shipment or shipping agreement. As a result, the customer computing device 315 may access, via the associated dashboard, account, interface, or the like, updated information associated with the shipping agreement. It should be appreciated that the server 309 may analyze, using the machine learning model, any updated data received from the data source(s) 320, which may result in a different output (i.e., a different vehicle that is deemed most likely to be transporting the products). Thus, in association with updating the associated dashboard, account, interface, or the like, the server 309 may indicate a new likely vehicle.

It should further be appreciated that the server 309 may be configured to generate any type of notification, electronic message (e.g., email), or the like in association with processing the output from the machine learning model. Additionally, the server 309 may transmit or communicate the notification or message via any type of electronic delivery medium, network, or the like. Further, the notification or message may include various graphical or textual content for the associated user to review.

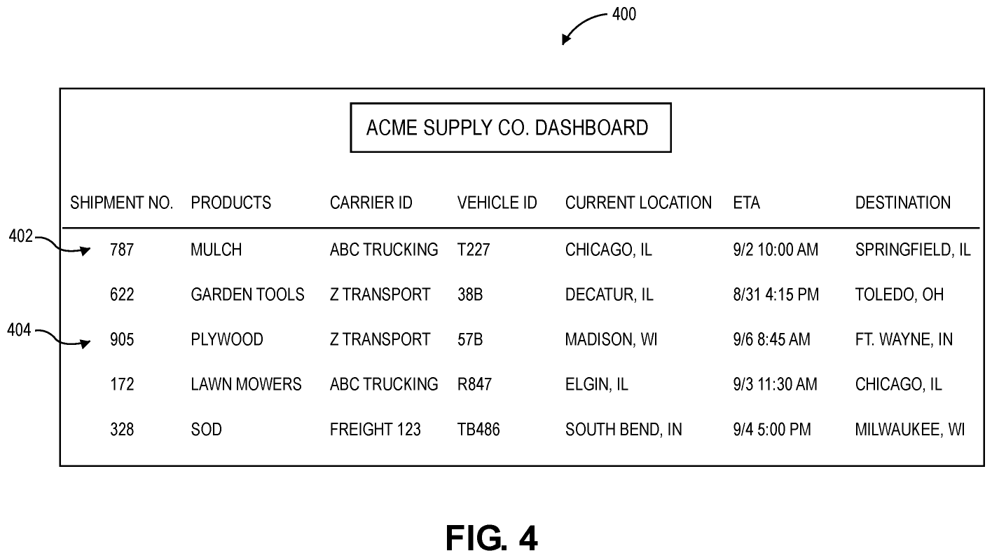

FIG. 4 is an example interface 400 associated with an example shipper entity (as shown: “Acme Supply Co.”). According to embodiments, a user associated with the shipper entity may use a computing device to access the interface 400. Additionally, a server (e.g., the server 109) may generate or determine the information included in the interface 400, as discussed herein. It should be appreciated that the interface 400 is merely an example, and that additional or alternative information is envisioned.

Generally, the interface 400 may indicate current shipping agreements that the shipper entity has with various carrier entities. The interface 400 may include, for each shipping agreement, the following information: shipment number, products being transported, carrier identification, vehicle identification, current location of the vehicle, an estimated time of arrival for the shipment, and a destination.

The interface 400 enables the user to review information and assess current locations of vehicles and estimated times of arrivals for multiple shipments across multiple carriers. For example, row 402 of the interface 400 indicates shipment number 787 that corresponds to ABC Trucking transporting mulch on vehicle ID T227 at a current location in Chicago, Ill. and with an ETA of September 2 in Springfield, Ill. at 10:00 AM. For further example, row 404 of the interface 400 indicates shipment number 905 that corresponds to Z Transport transporting plywood on vehicle ID 57B at a current location in Madison, Wis. and with an ETA of September 6 in Fort Wayne, Ind. at 8:45 AM.

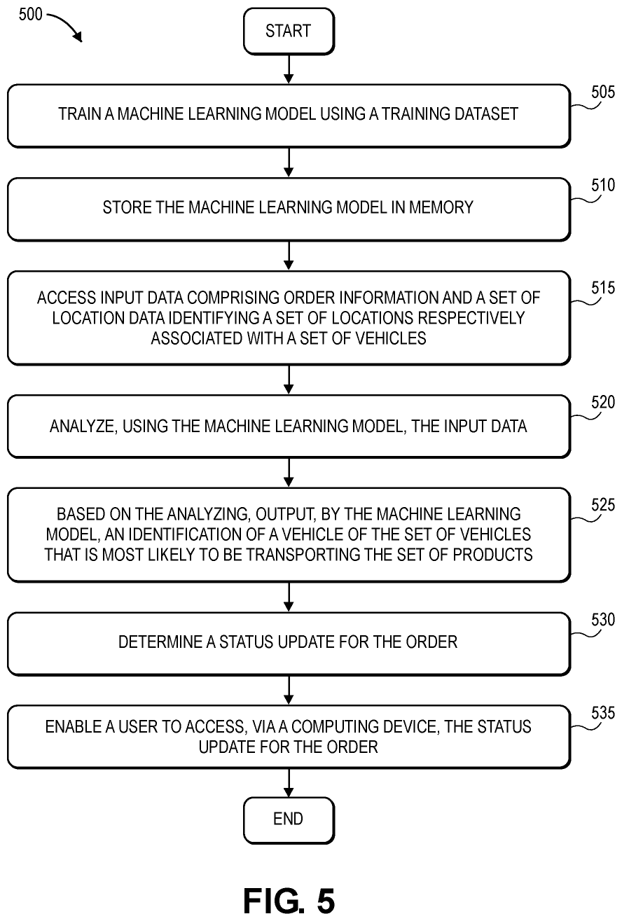

FIG. 5 depicts is a block diagram of an example method 500 of using machine learning for transportation assignment. The method 500 may be facilitated by an electronic device (such as the server 109 as depicted in FIG. 1A). In embodiments, the electronic device may communicate with a set of data sources and a set of computing devices. As discussed herein, it should be appreciated that the electronic device may execute or facilitate the method 500 without training or using a machine learning model, and instead accesses/receives data and analyzes the data to generate output data.

The method 500 may begin when the electronic device trains (block 505) a machine learning model using a training dataset. According to embodiments, the training dataset may include a training set of origin locations, a training set of destination locations, and a training set of location data. Further, the electronic device may store (block 510) the machine learning model in memory.

The electronic device may access (block 515) input data comprising order information (i.e., shipment information) and a set of location data identifying a set of locations respectively associated with a set of vehicles associated with a carrier entity. According to embodiments, the order information may be associated with an order or a shipment for a set of products (i.e., a shipment of products) to be transported by the set of vehicles associated with the carrier entity. The order information may indicate a first timing window for when the order/set of products is scheduled to be picked up, a second timing window for when the order/set of products is scheduled to be delivered, an origin location, and/or a destination location. Further, the set of location data may be associated with the carrier entity and the set of vehicles may be associated with the carrier entity. Additionally, the electronic device may receive, from a computing device via a network connection, the set of locations generated by a set of electronic logging devices respectively associated with the set of vehicles.

The electronic device may analyze (block 520), using the machine learning model, the input data. According to embodiments, the electronic device may determine a route from the origin location to the destination location, and the electronic device may input, into the machine learning model, a current time, the first timing window, the second timing window, the route, and the set of location data.

The electronic device may, based on the analyzing, output (block 525), by the machine learning model, an identification of a vehicle of the set of vehicles that is most likely to be transporting the set of products. According to embodiments, the machine learning model may output a set of probabilities respectfully associated with the set of vehicles, wherein each probability of the set of probabilities indicates a likelihood that the corresponding vehicle is transporting the set of products.

The electronic device may also determine (block 530) a status update for the order, for example based on the identification of the vehicle and a location of the set of locations associated with the vehicle. The electronic device may further enable (block 535) a user to access, via a computing device, the status update for the order. According to embodiments, the electronic device may also access updated location data for the vehicle (e.g., from the electronic logging device associated with the vehicle), and update the status update for the order, which may be accessible by the user via the computing device. Accordingly, the user may have access to an up-to-date status of the order and the shipment of the order.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of using machine learning for transportation assignment, the method comprising:
training, by a computer processor, a machine learning model using a training dataset comprising (i) a training set of origin locations, (ii) a training set of destination locations, and (iii) a training set of location data;
storing the machine learning model in a memory;
accessing, by the computer processor, input data comprising (i) order information indicating a origin location and a destination location for an order for a set of products, and (ii) a set of location data associated with a carrier entity and identifying a set of locations respectively associated with a set of vehicles associated with the carrier entity;
analyzing, by the computer processor using the machine learning model, the input data; and
based on the analyzing, outputting, by the machine learning model, an identification of a vehicle of the set of vehicles that is most likely to be transporting the set of products.

2. The computer-implemented method of claim 1, further comprising:
determining, by the computer processor based on the identification of the vehicle and a location of the set of locations associated with the vehicle, a status update for the order; and
enabling a user to access, via a computing device, the status update for the order.

3. The computer-implemented method of claim 2, further comprising:
accessing, by the computer processor, updated location data for the vehicle; and
updating, by the computer processor, the status update for the order.

4. The computer-implemented method of claim 1, wherein accessing the set of location data comprises:
receiving, from a computing device via a network connection, the set of locations generated by a set of electronic logging devices respectively associated with the set of vehicles.

5. The computer-implemented method of claim 1, wherein the order information further indicates a first timing window for when the order is scheduled to be picked up and a second timing window for when the order is scheduled to be delivered.

6. The computer-implemented method of claim 5, further comprising:
determining a route from the origin location to the destination location; wherein analyzing, using the machine learning model, the input data comprises:
inputting, into the machine learning model, a current time, the first timing window, the second timing window, the route, and the set of location data.

7. The computer-implemented method of claim 1, where outputting the identification of the vehicle comprises:
based on the analyzing, outputting, by the machine learning model, a set of probabilities respectfully associated with the set of vehicles, wherein each probability of the set of probabilities indicates a likelihood that the corresponding vehicle is transporting the set of products.

8. A system for using machine learning for transportation assignment, comprising:
a memory storing a set of computer-readable instructions and data associated with a machine learning model; and
a processor interfaced with the memory, and configured to execute the set of computer-readable instructions to cause the processor to:
train the machine learning model using a training dataset comprising (i) a training set of origin locations, (ii) a training set of destination locations, and (iii) a training set of location data,
access input data comprising (i) order information indicating a origin location and a destination location for an order for a set of products, and (ii) a set of location data associated with a carrier entity and identifying a set of locations respectively associated with a set of vehicles associated with the carrier entity,
analyze, using the machine learning model, the input data, and
based on the analyzing, output, by the machine learning model, an identification of a vehicle of the set of vehicles that is most likely to be transporting the set of products.

9. The system of claim 8, wherein the processor is configured to execute the set of computer-readable instructions to further cause the processor to:
determine, based on the identification of the vehicle and a location of the set of locations associated with the vehicle, a status update for the order, and
enable a user to access, via a computing device, the status update for the order.

10. The system of claim 9, wherein the processor is configured to execute the set of computer-readable instructions to further cause the processor to:
access updated location data for the vehicle, and
update the status update for the order.

11. The system of claim 8, wherein the processor accesses the set of location data by receiving, from a computing device via a network connection, the set of locations generated by a set of electronic logging devices respectively associated with the set of vehicles.

12. The system of claim 8, wherein the order information further indicates a first timing window for when the order is scheduled to be picked up and a second timing window for when the order is scheduled to be delivered.

13. The system of claim 12, wherein the processor is configured to execute the set of computer-readable instructions to further cause the processor to:
determine a route from the origin location to the destination location;
wherein to analyze, using the machine learning model, the input data, the processor is configured to:
input, into the machine learning model, a current time, the first timing window, the second timing window, the route, and the set of location data.

14. The system of claim 8, where to output the identification of the vehicle, the processor is configured to:
based on the analyzing, output, by the machine learning model, a set of probabilities respectfully associated with the set of vehicles, wherein each probability of the set of probabilities indicates a likelihood that the corresponding vehicle is transporting the set of products.

15. A non-transitory computer-readable storage medium configured to store instructions executable by a computer processor, the instructions comprising:
instructions for training a machine learning model using a training dataset comprising (i) a training set of origin locations, (ii) a training set of destination locations, and (iii) a training set of location data;
instructions for storing the machine learning model in a memory;
instructions for accessing input data comprising (i) order information indicating a origin location and a destination location for an order for a set of products, and (ii) a set of location data associated with a carrier entity and identifying a set of locations respectively associated with a set of vehicles associated with the carrier entity;
instructions for analyzing, using the machine learning model, the input data; and
instructions for, based on the analyzing, outputting, by the machine learning model, an identification of a vehicle of the set of vehicles that is most likely to be transporting the set of products.

16. The non-transitory computer-readable storage medium of claim 15, wherein the instructions further comprise:
instructions for determining, based on the identification of the vehicle and a location of the set of locations associated with the vehicle, a status update for the order; and
instructions for enabling a user to access, via a computing device, the status update for the order.

17. The non-transitory computer-readable storage medium of claim 16, wherein the instructions further comprise:
instructions for accessing updated location data for the vehicle; and
instructions for updating the status update for the order.

18. The non-transitory computer-readable storage medium of claim 15, wherein the order information further indicates a first timing window for when the order is scheduled to be picked up and a second timing window for when the order is scheduled to be delivered.

19. The non-transitory computer-readable storage medium of claim 18, wherein the instructions further comprise:
instructions for determining a route from the origin location to the destination location; wherein the instructions for analyzing, using the machine learning model, the input data comprise:
instructions for inputting, into the machine learning model, a current time, the first timing window, the second timing window, the route, and the set of location data.

20. The non-transitory computer-readable storage medium of claim 15, where the instructions for outputting the identification of the vehicle comprise:
instructions for, based on the analyzing, outputting, by the machine learning model, a set of probabilities respectfully associated with the set of vehicles, wherein each probability of the set of probabilities indicates a likelihood that the corresponding vehicle is transporting the set of products.

21. A computer-implemented method of assessing transportation of products, the method comprising:
accessing, by a processor, shipment information indicating a destination location for a shipment for a set of products to be transported by a set of vehicles associated with a carrier entity;
receiving, by the processor from a computing device via a network connection, a set of locations generated by a set of electronic logging devices respectively associated with the set of vehicles associated with the carrier entity;
analyzing, by the computer processor, the shipment information and the set of locations; and
based on the analyzing, determining an identification of a vehicle of the set of vehicles that is most likely to be transporting the set of products.

22. The computer-implemented method of claim 21, further comprising:
determining, by the computer processor based on the identification of the vehicle and a location of the set of locations associated with the vehicle, a status update for the shipment; and
enabling a user to access the status update for the shipment.

23. The computer-implemented method of claim 22, further comprising:
accessing, by the computer processor, updated location data for the vehicle; and
updating, by the computer processor, the status update for the shipment.

24. The computer-implemented method of claim 21, wherein the shipment information further indicates a first timing window for when the shipment is scheduled to be picked up and a second timing window for when the shipment is scheduled to be delivered.

25. The computer-implemented method of claim 21, where determining the identification of the vehicle comprises:
based on the analyzing, determining a set of probabilities respectfully associated with the set of vehicles, wherein each probability of the set of probabilities indicates a likelihood that the corresponding vehicle is transporting the shipment of products.

26. The computer-implemented method of claim 21, wherein the shipment information further indicates an origin location.
